(19) United States
(12) Patent Application Publication
(10) Pub. No.: US 2005/0249987 A1
(43) Pub. Date: Nov. 10, 2005

(54) Fault tolerant fuel cell systems

(75) Inventor: Gerard Francis McLean, West Vancouver (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: Angstrom Power Incorporated, North Vancouver (CA)

(21) Appl. No.: 11/075,997

(22) Filed: Mar. 10, 2005

Related U.S. Application Data
(60) Provisional application No. 60/567,432, filed on May 4, 2004.

(51) Int. Cl. H01M 8/00

(52) U.S. Cl. 429/12; 429/18; 429/34

(57) ABSTRACT

A fuel cell system comprises a plurality of groups of fuel cells electrically connected in series-parallel. Each of the groups of fuel cells comprises a plurality of fuel cells connected in series-parallel. Each of the fuel cells may have a very small active area. The system provides passive fault tolerance for both open-circuit and closed-circuit failures of individual fuel cells.

### CROSS-REFERENCE TO RELATED APPLICATION

The benefit of U.S. application No. 60/567,432 filed on 4 May, 2004 is claimed herein.

### TECHNICAL FIELD

The invention relates to fuel cells and, in particular to systems comprising a plurality of interconnected fuel cells for producing electrical power.

### BACKGROUND

Fuel cells produce electricity directly from the oxidation of a fuel. Since individual fuel cells produce only low voltages (typically on the order of 1 volt) it is generally necessary to connect a number of fuel cells in series to obtain electricity at a desired voltage. For this reason, fuel cells are often supplied in stacks. A stack of fuel cells is a unit within which a number of fuel cells are electrically connected in series. The stack typically provides common manifolds for the supply of fuel and oxidant to the cells. In a large fuel cell power system a number of stacks may be connected in parallel so that the fuel cell system can supply a desired load.

Individual fuel cells occasionally fail. For typical fuel cell applications it is desirable that a fuel cell system be operative for times on the order of 5,000 or more hours between anticipated failures.

Some fuel cell systems include active switching circuitry that can disconnect a failed or failing fuel cell and substitute a redundant fuel cell in its place. Some examples of such systems are:
the systems being developed by Avista Laboratories Inc. of Spokane Wash., USA;
the systems described in Christensen, U.S. Pat. No. 6,703,722; and Fuglevand et al., U.S. Pat. No. 6,387,556; and,
the systems described in Kawakami, U.S. Pat. No. 5,744,936.

Other systems monitor the performance of fuel cells. When such a system senses that a particular fuel cell is at risk of failure then remedial action can be taken. An example of a system that may be used to monitor the performance of individual fuel cells is the BHM™ system available from Estco Battery Management, Inc. of Nepean, Ontario, Canada and described in Dunn et al., U.S. Pat. No. 6,239,579; Adams et al. U.S. Pat. No. 6,339,313; and, Adams et al., U.S. Pat. No. 6,541,941.

Systems of the type noted above can be expensive, include components which can themselves fail, consume electrical power and take up space. Such systems are particularly impractical for use in association with small relatively low power fuel cell systems.

Badding et al. U.S. Pat. No. 6,623,881 discloses a fuel cell apparatus which includes arrays of electrodes disposed on a compliant electrolyte sheet. The electrodes are electrically connected by way of vias filled with electrically conducting materials. A cell can utilize both series and parallel connections between electrodes. The Badding et al. fuel cells operate at temperatures on the order of 700° C.

Yamanis, U.S. Pat. No. 6,589,681 discloses the provision of a parallel electrical conductor between corresponding conducting plates of two fuel cell stacks. Such conductors can be provided between each cell of both stacks or at a higher cell level in which there are two or more unconnected cells that intervene between connected cells of both stacks. Two, three or four radial stacks can be connected at the cell level or at higher cell levels.

Isenberg, U.S. Pat. No. 4,395,468 discloses high temperature solid oxide electrolyte fuel cell generators comprising an array of tubular cells electrically connected in a series-parallel configuration.

Crome et al. U.S. Pat. No. 5,985,113 discloses an array of tubular ceramic elements that may be used as fuel cells. The elements are electrically connected in a series-parallel configuration.

Hirota, U.S. Pat. No. 5,141,824 discloses a plurality of fuel cell stacks operated in electrically parallel connection or in series-parallel connection.

Despite the extensive research that has been done in the field of fuel cells, there remains a need for fuel cell systems which are both cost effective and reliable.

### SUMMARY OF THE INVENTION

This invention relates to fuel cell systems which include a number of fuel cells interconnected to provide electrical power. In the fuel cell systems the failure of a single fuel cell, or, in many cases, a few fuel cells does not degrade the output of the fuel cell system unacceptably.

One aspect of the invention provides a fuel cell system comprising a plurality of fuel cells supplied with fuel by way of a common fuel plenum. The fuel cells are electrically interconnected in a hierarchical series-parallel arrangement. The arrangement comprises a plurality of first groups of fuel cells. The first groups are connected in series-parallel with one another. Each of the first groups comprises a plurality of fuel cells connected in series-parallel.

Another aspect of the invention provides fuel cell systems having a plurality of fuel cells electrically interconnected in a series-parallel arrangement. Each of the fuel cells has an active area not exceeding 5%, or not exceeding 1% in some embodiments, of a total active area of fuel cells in the fuel cell system. At least a plurality of the fuel cells are connected to a fuel supply by way of a segmented fuel manifold comprising a plurality of flow restrictions arranged such that one of the flow restrictions is upstream in the fuel manifold from each of the plurality of the fuel cells and not all of the plurality of the fuel cells are downstream from the same one of the flow restrictions.

Another aspect of the invention provides fuel cell systems comprising a plurality of fuel cells electrically interconnected in a series-parallel arrangement. Each of the fuel cells has an active area not exceeding 1 cm² (not exceeding 0.5 cm² or 0.15 cm² or 0.05 cm² in some embodiments) and not exceeding 5% or, in some embodiments, 1% of a total active area of fuel cells in the fuel cell system.

Another aspect of the invention provides fuel cell systems comprising a plurality of fuel cells electrically interconnected in a hierarchical series-parallel arrangement. The arrangement comprises a plurality of first groups of fuel cells. The first groups are connected in a series-parallel circuit with one another. Each of the first groups comprises a plurality of fuel cells connected in series-parallel.

Embodiments of the invention advantageously include a large number of fuel cells. Failure of any one fuel cell in either a short-circuit mode or an open-circuit mode does not significantly affect the overall operation of fuel cell systems according to the invention.

A further aspect of the invention provides a fuel cell system comprising a number, N, of fuel cells sup[plied with fuel by a common fuel plenum and electrically interconnected in a series-parallel arrangement. The series-parallel arrangement comprises a plurality of series-groups each series-group comprising between two and N/4 fuel cells connected in series, the series groups connected in series-parallel with one another to provide the series-parallel arrangement. None of the series-groups is connected in parallel with more than N/4 other ones of the series-groups. In some embodiments each of the fuel cells has an active area not exceeding 5% of a total active area of fuel cells in the fuel cell system and not exceeding 1 cm².

Further aspects of the invention and features of specific embodiments of the invention are described below.

### BRIEF DESCRIPTION OF THE DRAWINGS

In drawings which illustrate non-limiting embodiments of the invention,

FIG. 1 is a block diagram of a fuel cell system according to one embodiment of the invention;

FIG. 2 is a block diagram illustrating a fuel delivery system supplying gaseous fuel to a few of the fuel cells of a system according to an embodiment of the invention;

FIG. 2A is a block diagram illustrating a fuel delivery system supplying gaseous fuel to a few groups of the fuel cells of a system according to an embodiment of the invention;

FIG. 3 is a block diagram illustrating a fuel cell system incorporating blocking diodes; and,

FIGS. 4A through 4D are schematic drawings of various alternative ways in which fuel cells may be electrically interconnected in systems according to the invention.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

Some embodiments of this invention provide fuel cell systems which include a large number (e.g. more than 100) individual fuel cells electrically connected in a series-parallel arrangement. The fuel cells are individually relatively small, in some cases, each generating not more than about 0.5% of a total power of the array. In some embodiments, the total power of the array is itself small (e.g. 20 Watts or less).

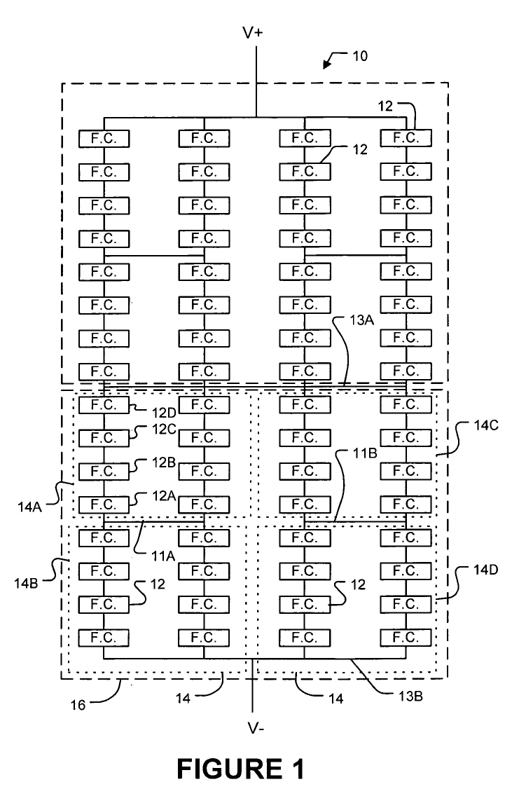

FIG. 1 shows a fuel cell system 10 according to a simple embodiment of the invention. Fuel cell system 10 includes a plurality of electrically interconnected fuel cells 12. System 10 is illustrated as including only a few fuel cells 12. A more typical implementation of the invention would include many more, for example, at least 100, several hundred, at least 500, one thousand or more or even several thousand fuel cells.

Each individual fuel cell 12 produces only a small fraction of the total power generated by system 10. Typically, each individual fuel cell 12 generates less than 0.5% and preferably less than 0.2% of the total power of system 10.

Fuel cell systems of some embodiments of the invention comprise fuel cells connected in hierarchical series-parallel arrangements. In such arrangements, a number of groups of fuel cells are electrically interconnected with one another in a series-parallel arrangement. Each of the groups of fuel cells includes a plurality of individual fuel cells interconnected with one another in a series-parallel arrangement. Such arrangements provide enhanced ability to deal with failures of individual fuel cells 12. In some embodiments the groups of fuel cells each include four or more fuel cells 12 or sets of series-connected fuel cells 12 connected in parallel.

Fuel cells 12 are interconnected in an arrangement in which individual fuel cells 12 are interconnected to provide blocks 14 within which the individual fuel cells are interconnected in a series-parallel configuration.

In some embodiments a the series-parallel configuration comprises sets of series-connected fuel cells 12 connected in parallel with one another. Each set of series-connected fuel cells includes 2 or more fuel cells. In some cases, each set of series-connected fuel cells comprises 3 or more fuel cells. In some cases each set of series-connected fuel cells comprises up to N/10 or N/4 series-connected fuel cells, where N is a total number of fuel cells in the fuel cell system. As shown in FIG. 1, each block 14 may comprise 2 or more sets of series-connected fuel cells connected in parallel with one another. In some cases, some or all blocks 14 comprise 4 or 5 or more sets of series-connected fuel cells connected in parallel with one another.

Blocks 14 are, in turn, interconnected in series-parallel with other blocks 14 to form composite blocks 16. Composite blocks 16 may, in turn, be interconnected in series-parallel with other composite blocks 16 to form larger composite blocks (not shown in FIG. 1).

In some embodiments (for example in the embodiment of FIG. 1) each group 14 is interconnected to other groups 14 only at its ends. That is, in such embodiments, there are no electrical connections made to other groups at locations between two fuel cells 12 of the same group 14 that are connected in series with one another. In some embodiments, for example, the embodiment of FIG. 1, composite blocks 16 include two or more groups 14 connected in series with one another between each electrical connection that places groups 14 in parallel with one another. For example, in FIG. 1, groups 14A and 14B are connected in series with one another between electrical connections 13A and 13B which place groups 14A and 14B in parallel with groups 14C and 14D. In the illustrated embodiment, there are no intermediate parallel connections (e.g. there is no direct electrical connection between nodes 11A and 11B).

The electrical interconnection of fuel cells 12 in system 10 prevents the operation of system 10 from being significantly degraded by the failure of a few individual fuel cells. For example, consider the case where any one or more of fuel cells 12A, 12B, 12C, and 12D fails in an open-circuit mode. Such a failure effectively removes all of fuel cells 12A, 12B, 12C, and 12D from system 10. However, delivery of electrical power from all of the other fuel cells 12 in system 10 is unaffected by such a failure.

If any one of fuel cells 12A, 12B, 12C, and 12D fails in a closed-circuit mode then the result is that the voltage produced by the series-connected fuel cells 12A, 12B, 12C, and 12D will be slightly reduced. However, the overall operation of system 10 will not be significantly affected if system 10 includes a large enough number of fuel cells 12.

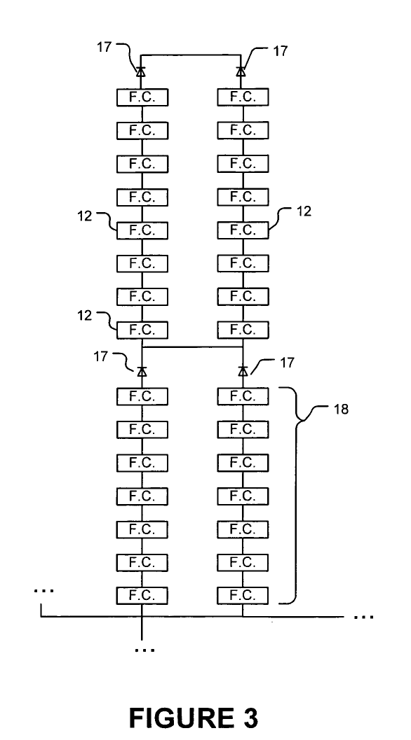

In some embodiments of the invention it is practical to integrate blocking diodes to prevent current from flowing in reverse through any series-connected fuel cells in which one or more fuel cells had failed in a closed-circuit manner. FIG. 3 shows a portion of a fuel cell system 10A which includes blocking diodes 17. Each diode 17 prevents reverse current flow through a corresponding group 18 of series-connected fuel cells 12.

In some embodiments of the invention, fuel cells 12 consume gaseous fuel, such as hydrogen gas (H₂) and a gaseous oxidant such as air or oxygen to produce electricity. Such fuel cells typically include a proton exchange membrane (“PEM”) which prevents the fuel and oxidant from coming into direct contact with one another. Some failure modes for fuel cells involve rupture of the PEM. In preferred embodiments of this invention, the individual fuel cells are small enough, both in absolute terms and in proportion to the total number of fuel cells in system 10 that the failure of the PEM in a few of the fuel cells will not interfere significantly with the production of electricity by system 10.

In particular embodiments of the invention the active area (i.e. the area of the PEM) of each fuel cell 12 is less than 1% and, in some cases, less than 0.5% or even less than 0.1% of the cumulative active areas of all of the fuel cells 12 of system 10. In some embodiments, the active areas of individual fuel cells 12 are smaller than 0.5 cm² and in some embodiments the active areas of individual fuel cells 12 do not exceed 0.15 cm² or even 0.05 cm². The lower limit of the active areas of individual fuel cells 12 is determined only by the design and fabrication techniques being used to produce fuel cells 12. Current fabrication technologies known to those skilled in the art permit fabrication of fuel cells having active areas on the order of 0.005 cm².

The shape of the active areas of fuel cells 12 can be further chosen to reduce the impact of the failure of a PEM in an individual fuel cell 12 by maximizing the pressure drop across the fuel gas supply to a ruptured cell. The pressure drop may be increased, by making the active areas narrow in comparison to their lengths. For example, the active areas may be at least substantially rectangular and have widths which are significantly smaller than their lengths. For example, each fuel cell 12 may have a length which is more than 5 times larger than the width. In some embodiments, the lengths of the active areas are approximately 10 times greater than the width. For example, in some embodiments of the invention, fuel cells 12 could have a length of 6 mm and a width of 0.6 mm to provide an active area of 0.036 cm².

In some embodiments of the invention, fuel cells 12 have a transverse dimension not exceeding 1 mm and a longitudinal dimension of 1 cm or more.

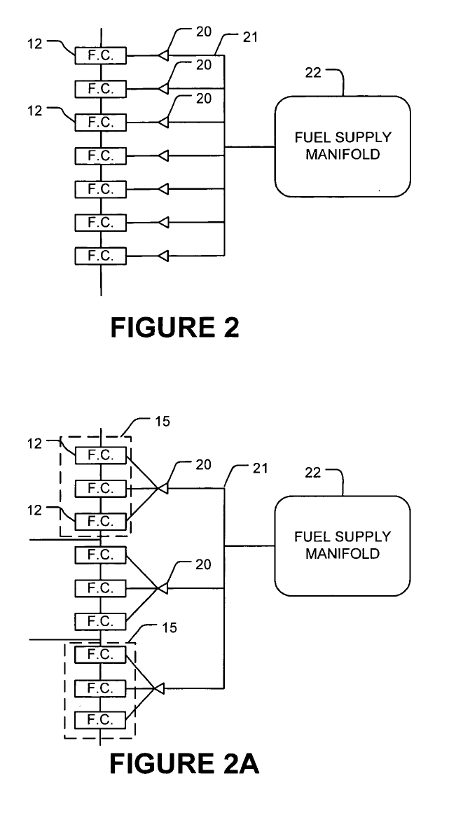

All of the fuel cells may be supplied with fuel by way of a common fuel plenum or manifold. To further limit the effect of the rupture of a PEM in a fuel cell 12, as shown in FIG. 2, fuel gas may be conducted to individual fuel cells by way of a plenum comprising gas lines 21 which include restrictions 20. Gas lines 21 may be provided by a single branching plenum, for example. The fuel gas may originate from a common fuel supply chamber 22.

Restrictions 20 further limit the effect of the rupture of a PEM in a fuel cell 12 by limiting the rate at which fuel gas can flow to the fuel cell with the ruptured membrane through the line 21 which supplies the fuel cell 12. Gas lines 21, as shown in FIG. 2 or 2A constitute a segmented fuel manifold. A rupture in the segment downstream from any of restrictions 20 will not significantly affect the supply of fuel to fuel cells supplied by other segments downstream from other restrictions 20.

In some embodiments of the invention, a separate gas line 21 serves more than one fuel cell 12. For example a gas line may serve several fuel cells 12. In some cases, a gas line 21 may serve a group 14 of fuel cells 12. FIG. 2A shows an embodiment of the invention wherein a single gas line 21 supplies fuel to a group 15 of fuel cells 12. Each fuel line 21 includes a restriction 20 upstream from the connections to the fuel cells 12 of the group 15.

The effect of rupture of a PEM in one of fuel cells 12 can be further reduced by maintaining the pressure of fuel gas at fuel cells 12 reasonably low. For example, the fuel gas may be at a gauge pressure of 1 atmosphere or less in manifold 22 and on the fuel side of normally operating fuel cells 12.

A system according to the invention may be designed to provide a desired amount of power by laying out groups of parallel-connected fuel cells with enough fuel cells in each of the groups to provide a desired degree of fault tolerance in respect of open-circuit failures. A number of such groups can be connected in series to provide a series-parallel set producing a desired output voltage. Several such series-parallel sets can be connected in parallel to yield a system having a desired power output at the desired voltage.

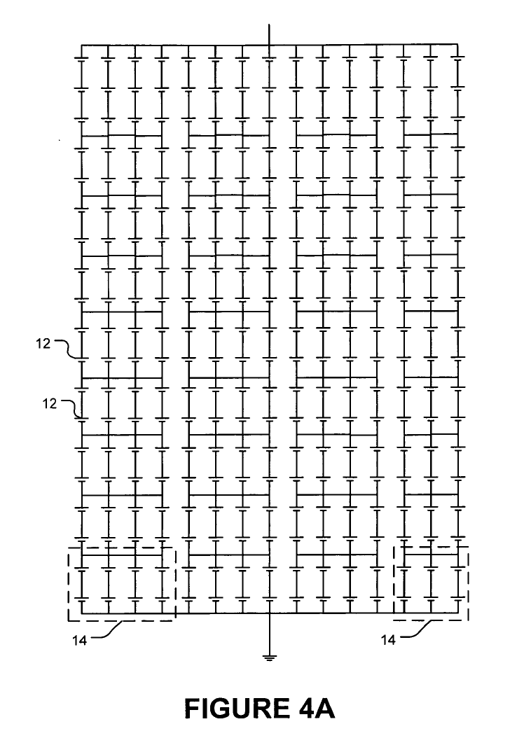

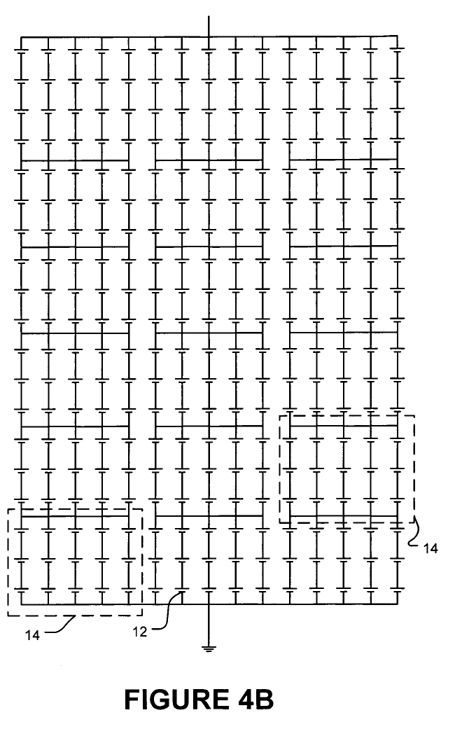

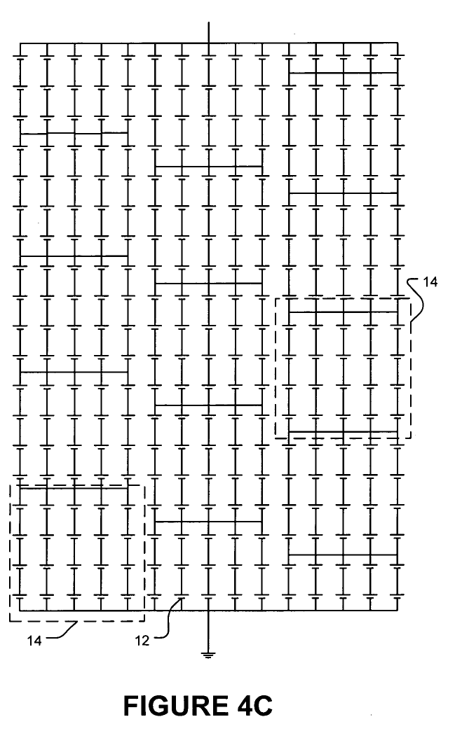

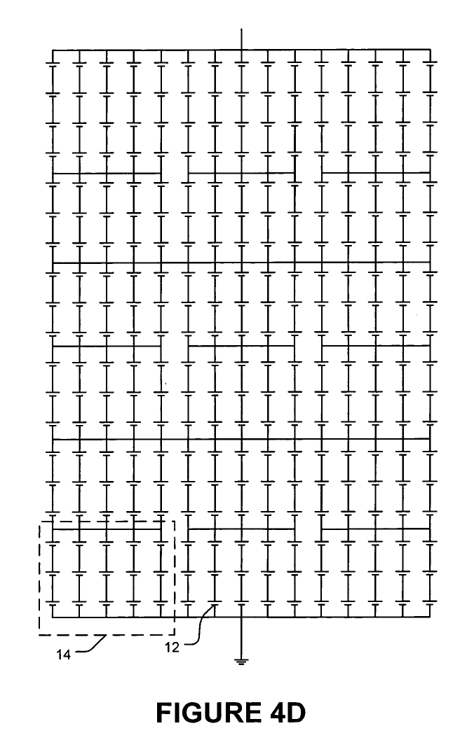

The specific way in which individual fuel cells are electrically interconnected can be varied without departing from the invention. FIGS. 4A through 4D show some illustrative examples. In each case, individual fuel cells are connected in series-parallel arrangements with other fuel cells to form blocks 14 of fuel cells. Some example blocks 14 are indicated in FIGS. 4A to 4D. Blocks 14 of fuel cells are connected in series-parallel with one another to make fuel cell systems.

In some embodiments of the invention, each of the blocks comprises several groups of series-connected fuel cells with the groups of series-connected fuel cells connected in parallel with one another. In some embodiments of the invention the groups of series-connected fuel cells each include 3 or more fuel cells connected in series. In some embodiments of the invention each block includes 4 or more groups of series-connected fuel cells connected in parallel with one another.

When designing a system 10 to provide higher output voltages, one must provide more fuel cells 12 connected in series to achieve the desired output voltage. In the embodiments described above, this is achieved by connecting enough blocks 14 in series to achieve the desired output voltage. In such cases, to reduce the probability that a combination of open-circuit fuel cell failures will significantly impair the operation of system 10, more individual fuel cells 12 can be connected in parallel within each block 14 and/or more blocks 14 can be connected in parallel with one another.

Fuel cell systems according to some embodiments of the invention have low power outputs (i.e. power outputs of 20 Watts or less) and in some cases power outputs of 2 Watts or less. Such systems may be used for supplying electrical power to devices such as portable computers, cellular telephones, flashlights, electronic diagnostic equipment and the like. Fuel cell systems according to low power embodiments of the invention have advantages over conventional fuel cell systems because they can continue to function despite the failure of one or more individual fuel cells and do not require complicated control systems to compensate for the failure of individual fuel cells. Some fuel cell systems according to the invention have power outputs of 200 mW or less.

Current fuel cell stacks including only a few individual fuel cells can readily supply electrical outputs of several watts at the voltages used by typical portable devices. In contrast, fuel cell systems according to this invention may have hundreds or even thousands of very small individual fuel cells. Each of the fuel cells in some embodiments of the invention have an electrical power output of 10 mW or less and in some cases 2 mW or less.

Some or all of fuel cells 12 may optionally be formed on common substrates. The substrates may be generally planar or may have other configurations, such as cylindrical configurations. In some embodiments of the invention all of fuel cells 12 are formed on a common substrate. In some embodiments groups of fuel cells in an array according to the invention are formed on common substrates and a fuel cell system comprises a plurality of common substrates each having a plurality of fuel cells disposed thereon. For example, a fuel cell array according to the invention may constitute fuel cells constructed as described in co-pending US patent application Ser. No. 11/047,557 entitled ELECTROCHEMICAL CELLS FORMED ON PLEATED SUBSTRATES or US patent application Ser. No. 11/047,560 entitled ELECTROCHEMICAL CELLS HAVING CURRENT-CARRYING STRUCTURES UNDERLYING REACTION LAYERS, both of which are hereby incorporated herein by reference.

Where a component (e.g. a fuel cell, regulator, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

As will be apparent to those skilled in the art in the light of the foregoing disclosure, many alterations and modifications are possible in the practice of this invention without departing from the spirit or scope thereof. For example:
The fuel cells are not necessarily PEM type fuel cells by could comprise fuel cells of other types.
The individual fuels cells are typically substantially identical. This is not mandatory, however.
Where a system comprises fuel cells arranged in a hierarchical series-parallel arrangement, the series-parallel groupings of fuel cells which are themselves interconnected in a series-parallel configuration are not necessarily identical to one another.
The invention may be applied to systems of electrochemical cells other than fuel cells.
   Accordingly, the scope of the invention is to be construed in accordance with the substance defined by the following claims.

1. A fuel cell system comprising a plurality of fuel cells,
the fuel cells supplied with fuel by way of a common fuel plenum;
the fuel cells electrically interconnected in a hierarchical series-parallel arrangement, the arrangement comprising a plurality of first groups of fuel cells, the first groups connected in series-parallel with one another, each of the first groups comprising a plurality of fuel cells connected in series-parallel.

2. A fuel cell system according to claim 1 comprising at least 100 interconnected fuel cells.

3. A fuel cell system according to claim 1 comprising at least 4 of the first groups connected in series with one another.

4. A fuel cell system according to claim 1 wherein the first groups of fuel cells comprise a plurality of sets of series-connected fuel cells connected in parallel.

5. A fuel cell system according to claim 4 wherein the first groups of fuel cells each comprise four or more of the series-connected sets of fuel cells connected in parallel.

6. A fuel cell system according to claim 5 wherein each of the sets of series-connected fuel cells comprises three or more fuel cells connected in series.

7. A fuel cell system according to claim 4 wherein each of the sets of series-connected fuel cells comprises three or more fuel cells connected in series.

8. A fuel cell system according to claim 1 wherein each of the fuel cells is disposed on a sheet-like substrate with a plurality of other ones of the fuel cells.

9. A fuel cell system according to claim 8 wherein all of the fuel cells are disposed on the sheet-like substrate.

10. A fuel cell system according to claim 8 wherein the sheet-like substrate constitutes one of a plurality of sheet-like substrates and a plurality of the fuel cells are disposed on each one of the plurality of sheet-like substrates.

11. A fuel cell system according to claim 8 wherein the substrate is generally planar.

12. A fuel cell system according to claim 8 wherein the substrate is generally cylindrical.

13. A fuel cell system according to claim 8 wherein electrical connections between the fuel cells are provided by electrically conducting traces deposited on the substrate.

14. A fuel cell system according to claim 1 comprising at least 500 interconnected fuel cells.

15. A fuel cell system according to claim 1 wherein each of the fuel cells has an active area not exceeding 1% of a total active area of fuel cells in the fuel cell system.

16. A fuel cell system according to claim 1 wherein the active area of each of the fuel cells does not exceed 1 cm².

17. A fuel cell system according to claim 1 wherein the active area of each of the fuel cells does not exceed 0.5 cm².

18. A fuel cell system according to claim 1 wherein each of the fuel cells has an active area not exceeding 0.05 cm².

19. A fuel cell system according to claim 1 wherein each of the fuel cells has an elongated active area.

20. A fuel cell system according to claim 1 wherein each of the fuel cells has an active area having an average width and an average length wherein the average width of the active area does not exceed 15% of the average length of the active area.

21. A fuel cell system according to claim 1 wherein each of the fuel cells has an active area that has a longitudinal dimension at least 5 times greater than a transverse dimension of the active area.

22. A fuel cell system according to claim 1 wherein the common fuel plenum comprises a segmented fuel manifold comprising a plurality of flow restrictions arranged such that one of the flow restrictions is upstream in the fuel plenum from each of the plurality of the fuel cells and not all of the plurality of the fuel cells are downstream from the same one of the flow restrictions.

23. A fuel cell system according to claim 22 wherein the segmented fuel manifold comprises a plurality of flow restricting passages, each one of the flow restricting passages connecting a corresponding one of the fuel cells to a common manifold.

24. A fuel cell system according to claim 1 wherein the fuel cells are operative to produce electrical power at temperatures below 100° C.

25. A fuel cell system according to claim 1 wherein a plurality of the first groups of fuel cells comprise blocking diodes connected in series with series-connected groups of the fuel cells.

26. A fuel cell system comprising a plurality of fuel cells electrically interconnected in a series-parallel arrangement,
each of the fuel cells having an active area not exceeding 5% of a total active area of fuel cells in the fuel cell system,
at least a plurality of the fuel cells connected to a fuel supply by way of a segmented fuel manifold comprising a plurality of flow restrictions arranged such that one of the flow restrictions is upstream in the fuel manifold from each of the plurality of the fuel cells and not all of the plurality of the fuel cells are downstream from the same one of the flow restrictions.

27. A fuel cell system according to claim 26 wherein each of the fuel cells is disposed on a sheet like substrate with a plurality of other ones of the fuel cells.

28. A fuel cell system according to claim 27 wherein the substrate is generally planar.

29. A fuel cell system according to claim 27 wherein the substrate is generally cylindrical.

30. A fuel cell system according to claim 26 comprising at least 500 interconnected fuel cells.

31. A fuel cell system according to claim 26 wherein each of the fuel cells has an active area not exceeding 0.15 cm².

32. A fuel cell system according to claim 26 wherein each of the fuel cells has an active area not exceeding 0.05 cm².

33. A fuel cell system according to claim 26 wherein each of the fuel cells has an elongated active area.

34. A fuel cell system according to claim 26 wherein each of the fuel cells has an active area having an average width and an average length wherein the average width of the active area does not exceed 15% of the average length of the active area.

35. A fuel cell system according to claim 26 wherein each of the fuel cells has an active area that has a longitudinal dimension at least 5 times greater than a transverse dimension of the active area.

36. A fuel cell system comprising a number, N, of fuel cells electrically interconnected in a series-parallel arrangement,
each of the fuel cells supplied with fuel by a common fuel plenum;
wherein the series-parallel arrangement comprises a plurality of sets of series-connected fuel cells each of the sets comprising between two and N/4 fuel cells connected in series, the sets connected in series-parallel with one another to provide the series-parallel arrangement;
wherein none of the sets of series-connected fuel cells is connected in parallel with more than N/4 other ones of the sets.

37. A fuel cell system according to claim 36 wherein each of the sets comprises between two and N/10 fuel cells.

38. A fuel cell system according to claim 36 wherein none of the sets of series-connected fuel cells is connected in parallel with more than N/10 other ones of the sets.

39. A fuel cell system according to claim 36 wherein each of the fuel cells has an active area not exceeding 5% of a total active area of fuel cells in the fuel cell system.

40. A fuel cell system according to claim 39 wherein the active area of each of the fuel cells does not exceed 1 cm².

41. A fuel cell system according to claim 36 comprising at least 4 of the sets of series-connected fuel cells connected in series with one another.

42. A fuel cell system according to claim 36 wherein each of the sets of series-connected fuel cells is connected in parallel with three or more other ones of the sets of series-connected fuel cells.

43. A fuel cell system according to claim 42 wherein each of the sets of series-connected fuel cells comprises three or more fuel cells connected in series.

44. A fuel cell system according to claim 36 wherein each of the fuel cells is disposed on a sheet-like substrate with a plurality of other ones of the fuel cells.
